(19) United States
(12) Patent Application Publication
(10) Pub. No.: US 2012/0313739 A1
(43) Pub. Date: Dec. 13, 2012

(54) Proportional Electromagnet

(75) Inventors: Chuen-An Chen, Taoyuan County (TW); Chieh Tung, Taoyuan County (TW); Che-Pin Chen, New Taipei City (TW); Min-Fang Lo, Taoyuan County (TW); Yao-Ming Huang, Taoyuan County (TW)

(73) Assignee: Chung-Shan Institute of Science and Technology, Armaments, Bureau, Ministry of National Defense, Taoyuan County (TW)

(21) Appl. No.: 13/315,396

(22) Filed: Dec. 9, 2011

(30) Foreign Application Priority Data
Jun. 10, 2011 (TW) 100120280

(51) Int. Cl. H01F 7/20

(52) U.S. Cl. 335/297

(57) ABSTRACT

A proportional electromagnet includes a cylindrical shell, first and second covers connected to two ends of the shell by riveting, a metal core inserted through an axial defined in the second cover and formed with a first section located in the shell and a second section located outside the shell, a coil unit provided between the shell and the metal core, a supporting element provided on the first section of the metal core, a bushing provided on the second section of the metal core, a copper ring provided on the first section of the metal core to improve magnetic thrust of the proportional electromagnet, a stop provided on the first section of the metal core, and a magnetic shield provided between the first section of the metal core and the coil unit to direct magnetic flux toward the supporting element and the metal core to stably drive the metal core.

### BACKGROUND OF INVENTION

1. Field of Invention

The present invention relates to an electromagnet and, more particularly, to a proportional electromagnet.

2. Related Prior Art

An electromagnet is used for turning electricity into magnetism and often used where intermittent movement is desired. The electromagnet includes a coil around a metal core which includes a bore defined in an end. The bore jeopardizes the density of the magnetism. Therefore, the magnetism is not constant in an operative stroke.

Referring to FIG. 4, shown is a conventional electromagnetic apparatus 5 that includes a magnetic circuit. The magnetic circuit goes from a coil unit 51 into a magnetic shield via a first bushing 52, a magnetic lining 53, a first air gap 54, a metal core 55. Then, the magnetic circuit is divided into two branches.

One of the branches goes into a second air gap 56. The other branch goes into a supporting element 58 via a flange 57. Then, the magnetic circuit returns into the coil unit 51 via a second bushing 59. The bushings 52 and 59 and the air gaps 54 and 56 and the flange 57 are magnetic air gaps that exhibit a magnetic resistance about 400 to 800 times as high as magnetic metal about a same distance and area. Hence, an electromagnetic apparatus will operate inefficiently if includes many magnetic air gaps.

The present invention is therefore intended to obviate or at least alleviate the problems encountered in prior art.

### SUMMARY OF INVENTION

It is an objective of the present invention to provide a proportional electromagnet for providing substantially constant magnetism during an operative stroke.

To achieve the foregoing objective, the proportional electromagnet includes a cylindrical shell, first and second covers connected to two ends of the shell by riveting, a metal core inserted through an axial defined in the second cover and formed with a first section located in the shell and a second section located outside the shell, a coil unit provided between the shell and the metal core, a supporting element provided on the first section of the metal core, a bushing provided on the second section of the metal core, a copper ring provided on the first section of the metal core to improve magnetic thrust of the proportional electromagnet, a stop provided on the first section of the metal core, and a magnetic shield provided between the first section of the metal core and the coil unit to direct magnetic flux toward the supporting element and the metal core to stably drive the metal core. Other objectives, advantages and features of the present invention will be apparent from the following description referring to the attached drawings.

### BRIEF DESCRIPTION OF DRAWINGS

The present invention will be described via detailed illustration of the preferred embodiment versus prior art referring to the drawings wherein:

FIG. 1 is a cross-sectional view of a proportional electromagnet according to the preferred embodiment of the present invention;

FIG. 2 is a side view of a core of the proportional electromagnet shown in FIG. 1;

FIG. 3 shows magnetism produced by the proportional electromagnet shown in FIG. 1; and

FIG. 4 shows magnetism produced by a conventional electromagnet.

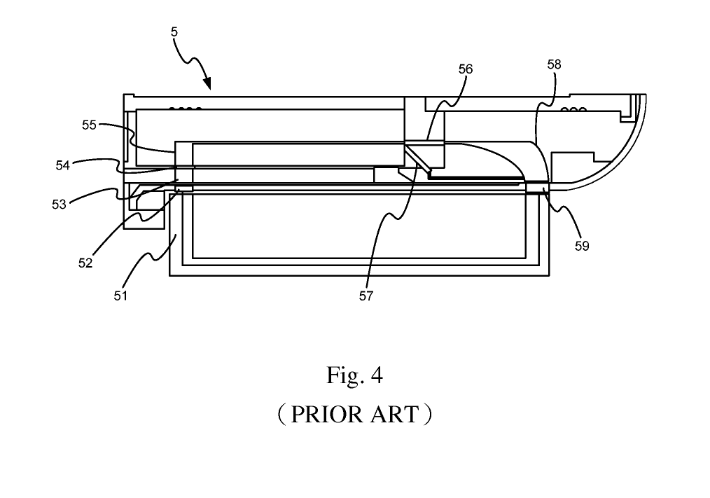

### DETAILED DESCRIPTION OF PREFERRED EMBODIMENT

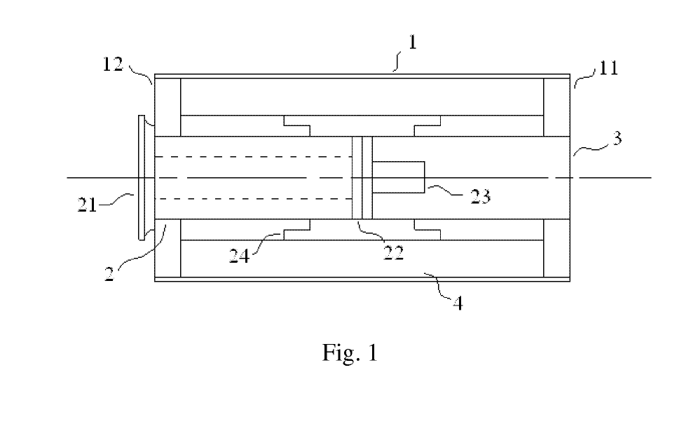

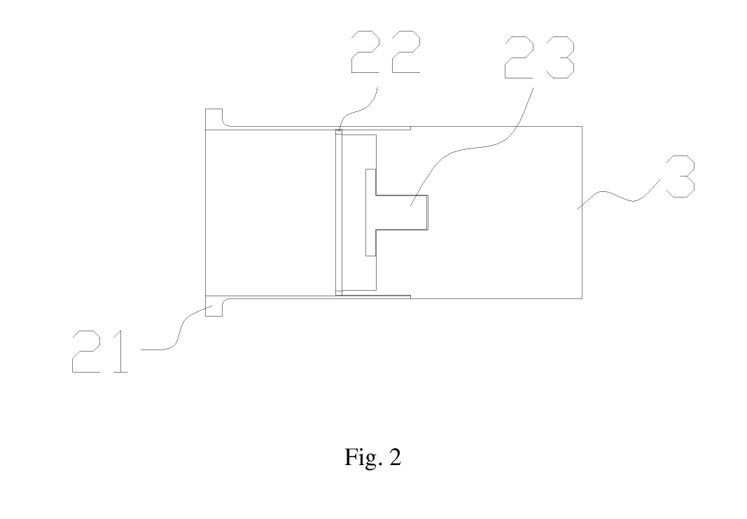

Referring to FIGS. 1 and 2, the proportional electromagnet includes a shell 1, a metal core 2, a supporting element 3 and a coil unit 4 according to the preferred embodiment of the present invention. The shell 1 is a cylindrical shell made of a sheet by rolling. Two covers 11 and 12 are secured to two ends of the shell 1 by rivets for example.

The metal core 2 is inserted in the shell 1. The metal core 2 includes a first end located outside the shell 1 and a second end inserted in the shell 1 and connected to the supporting element 3. Between the shell 1 and the metal core 2 is provided the coil unit 4.

A horn-shaped bushing 21 is connected to the first end of the metal core 2 while a copper ring 22 and a stop 23 are connected to the second end of the metal core 2. Between the metal core 2 and the coil unit 4 is provided a magnetic shield 24. The metal core 2 and the coil unit 4 are made of a same magnetic material or different magnetic materials. The bushing 21 and the stop 23 are made of stainless steel that is non-magnetic. The magnetic shield 24 is made of copper. The stop 23 is used to control the shortest distance between the supporting element 3 and the metal core 2 when they are attracted to each other because of magnetic excitement.

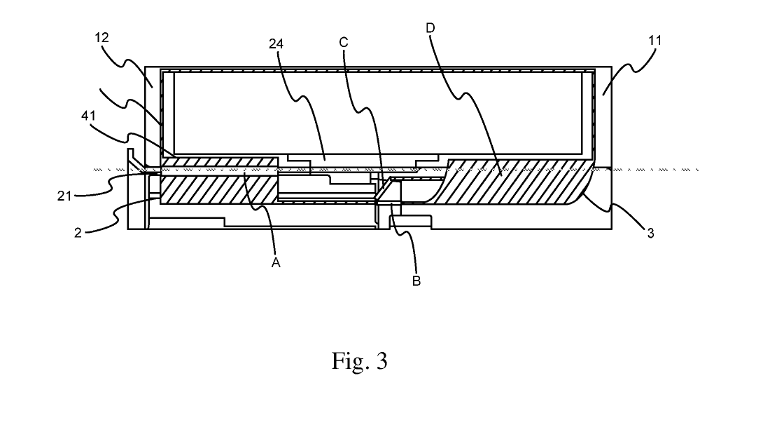

The present invention exhibits several advantageous features over the prior art. At first, subjected to a same electromotive force (“NI”), the present invention produces a magnetic circuit to provide a larger electromagnetic force than the prior art. Referring to FIG. 3, “A” stands for a non-magnetic metal magnetic circuit, “B” and “C” represent air gaps, and “D” refers to a magnetic metal magnetic circuit. A magnetic lining 41 is located close to the coil unit 4. The bushing 21 and the covers 11 and 12 are merged with the metal core 2. The magnetic circuit goes from the supporting element 3 into the magnetic shield 24 through the magnetic lining 41, the bushing 21 and the metal core 2, the magnetic shield 24. Then, the magnetic circuit is divided into two branches. One of the branches goes through the air gap B. The other branch returns to the supporting element through the air gap C. Then, the magnetic circuit goes into an end of the coil unit 4. The air gaps B and C produce magnetic circuits that are necessary for the proportional function while there is only the non-magnetic magnetic circuit A. The area of the magnetic circuit is 4 times as large as that of the prior art. The proportion of the air gaps B and C is reduced, and the magnetic resistance of the air gaps B and C is also reduced. Hence, the present invention provides a larger electromagnetic force than the prior art.

Secondly, a conical surface is used instead of a conventional wedge-like surface. Therefore, the present invention can be made more easily than the prior art without jeopardizing the performance.

Thirdly, the lining 21 is directly secured to the supporting element 3 by welding instead of the conventional caps that involve more difficult fabrication.

Fourthly, the present invention exhibits less magnetic resistance than the prior art because that the coil unit 4 is in direct contact with the supporting element 3.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A proportional electromagnet including:
a shell with a cylindrical configuration;
first and second covers connected to two ends of the shell by riveting;
a metal core inserted through an axial defined in the second cover and formed with a first section located in the shell and a second section located outside the shell;
a coil unit provided between the shell and the metal core;
a supporting element provided on the first section of the metal core;
a bushing provided on the second section of the metal core;
a copper ring provided on the first section of the metal core to improve magnetic thrust of the proportional electromagnet;
a stop provided on the first section of the metal core;
a magnetic shield provided between the first section of the metal core and the coil unit to direct magnetic flux toward the supporting element and the metal core to stably drive the metal core.

2. The proportional electromagnet according to claim 1, wherein the metal core is made a magnetic material.

3. The proportional electromagnet according to claim 1, wherein the metal core includes an aperture defined therein.

4. The proportional magnet according to claim 1, wherein the first and second covers are made of a magnetic material.

5. The proportional magnet according to claim 1, wherein the coil unit includes a coil and a sleeve provided around the coil.

6. The proportional magnet according to claim 5, wherein the sleeve and the coil are made of a magnetic material.

7. The proportional magnet according to claim 1, wherein the magnetic shield is made of copper.

8. The proportional magnet according to claim 1, wherein the bushing is made of stainless steel that is non-magnetic.

9. The proportional magnet according to claim 8, wherein the bushing is a horn-shaped element.

10. The proportional magnet according to claim 1, wherein the stop is made of stainless steel that is non-magnetic.

11. The proportional magnet according to claim 10, wherein the stop is used to control the shortest distance between the metal core and the supporting element after magnetic excitation.
